(19) United States
(12) Patent Application Publication
(10) Pub. No.: US 2002/0012037 A1
(43) Pub. Date: Jan. 31, 2002

(54) Device for transport of stock through a printing unit

(76) Inventors: Uwe Gerhard Angst, Jockrimg (DE); Uwe Fischer, Rostock (DE); Dirk Dobrindt, Klausdorf/Schwentine (DE); Erich Hein, Frankfurt (DE); Gary Lawniczak, Rochester, NY (US); Norbert Hans-Georg Neumann, Westensee/Brux (DE); Wiebke Pirell, Kiel (DE); Lutz Rebetge, Kiel (DE)

Correspondence Address: Lawrence P. Kessler, Patent Department, NexPress Solutions LLC, 1447 St. Paul Street, Rochester, NY, 14653-7103, US

(21) Appl. No.: 09/850,588

(22) Filed: May 7, 2001

(30) Foreign Application Priority Data
May 15, 2000 (DE) 100 23 828.9

(51) Int. Cl. B41J 2/01

(52) U.S. Cl. 347/104

(57) ABSTRACT

The invention concerns a device for transport of stock for a printing unit. The stock, in the form of paper or film, is taken up in different feeds (1, 2, 3). Inputs (26, 27, 28) are connected to them to introduce the stock into the stock feed path (7). The stock passes through a number of processing stations (6, 8, 11, 14, 22) along its stock feed path (7). The stock feed path (7, 13) contains a number of shunts (10, 17, 24) for the stock, with which unprinted stock passes through individual processing stations (6, 8, 11, 14, 29) or can be transported past them, can be fed to different delivery sites (18, 19) and/or already printed stock can be reintroduced to the stock feed sequence via a turning (22).

The present invention concerns a device for transport of stock through a printing unit, for example, a digital printer.

Stock in sheet form, be it paper, cardboard or film, is processed or printed in copiers or printing machines. Transport preferably occurs in copiers by individual belt pulls spaced from each other in the feed direction. In copiers, the stock partially undergoes very sharp deflections, owing to the compact design of these machines, so that thicker basis weights, like cardboard or film, cannot be processed, since they would cause paper jams in the copier, because of their rigidity.

The processable stock basis weight or stock rigidity in copiers is therefore restricted.

In sheet processing printers, the sheets are separated with suction air on the feed stack, grasped by suction heads and then aligned. The aligned sheets, aligned by pull-type lay marks and side marks, reach the end of the feed table in imbricate formation. There, the aligned sheets are grasped by pregrippers, which accelerate the sheets to the printing speed. The sheets are taken up by grippers, which are accommodated on the peripheral surfaces of sheet-processing and sheet-transporting cylinders. The sheets are transferred to the next printing group by means of sheet-guiding cylinders after passing one printing group. The layout of paper-guiding cylinders with grippers is very costly and requires very costly control by means of cam segments.

If sheet printing machines are operated in first print and verso print, turning can generally occur after the first printing group or perhaps in the center of the printing machine, depending on the layout. On the other hand, if the sheets are only printed on one side in the printing machine, they can be placed in a feed stack and turned by a stack turner and introduced back into the printing machine as a new feed stack, standing upright with the printed side down, so that the backside of the sheet initially printed on one side can also be printed. However, in this procedure, the entire run is printed on the backside. The flexibility of such a procedure is extremely limited, since, during sheet separation, which is extremely difficult because of the printed bottom of the sheet, all sheets are introduced through the sheet printing machine in the feed path and no branching is prescribed to turn only individual sheets. Individual two-sided printing of individual sheets with this procedure is therefore not possible.

Starting from the outlined solutions of the prior art in copiers or sheet processing printing machines, the underlying task of the invention is to implement a stock transport concept that reliably transports the stock from the feed to the delivery and can be handled with high guiding accuracy for different stock types and basis weights.

The task is solved according to the invention by the features of Patent claim 1.

The advantages of the proposed solution according to the invention are mostly seen in the fact that stock transport occurs in several planes through a printing machine that processes sheet-like material, in which individual branching stations are provided in the stock feed path. Because of this, individual processing stations, for example, predrying, can be selectively disconnected from the feed path of the stock or incorporated in it. Individual films or sheets can thus be guided through a digital printer. Depending on the printing and order requirements, individual sheets initially printed on one side can be fed to sheet turning and then fed back into the stock feed path. This permits individual stock processing in first print and verso print independent of the sheet separation sequence.

In another embodiment of the idea underlying the invention, the stock can be transported within the printing unit in superimposed planes. A uniform mounting surface for all components is provided on this account, which permits free access to the individual sections of the stock feed path, in addition to simple and cost-effective assembly possibilities, so that simple fluff removal can occur.

According to another embodiment of the idea underlying the invention, three stock feed stacks independent of each other are provided, each of which is equipped for introduction of stacked stock into the stock feed path via a separate input. Depending on order requirements, a stock feed sequence can be adjusted, in which, in the extreme case, a stock sheet an be sequentially removed from the feed stack so that an individual stock sequence can be achieved during passage through the individual components of the printing unit proposed according to the invention.

As soon as the corresponding stock copies are removed from the individual feed stations and introduced into the stock feed path, they pass through a double-sheet recognition, which can be designed, for example, as a capacitive or inductive, or also transmitted light sensor, which is arranged after a delivery station. After the delivery station, a synchronization region is connected within the stock feed path. In the stock feed concept through a printer unit proposed according to the invention, the stock sheets are preferably acted upon by roll pairs and belt arrangements that grasp the individual stock sheets on both sides and convey them through the essentially closed feed path. A predrying module is connected after the synchronization zone. By means of a branching site arranged in front of the predrying module in the form of a shunt, the individual stock sheets that have passed through the synchronization zone are introduced past the predrying module into a belt pull extending essentially in the horizontal position above the predrying module. From there, they go to further processing in an essentially horizontally running feed zone after 180° deflection.

Stock feed, be it paper sheets, cardboard sheets or even film sections in sheet form, essentially occurs through roll pairs of equal or unequal diameter arranged on both sides of the stock feed path, and through belt pulls, depending on the configuration and desired deflection. Belt pulls are preferably designed as central, elastic center belts that grasp the stock essentially in its center section, so that the processability of all stipulated stock formats is possible in the proposed printer unit according to the invention. The proposed stock concept according to the invention consists of a combination of cooperating roll and center belt feeding of the stock through the entire printer unit. Center belts are used in overlapping belt arrangements that do not influence the sheet position, but only serve for sheet transport, as well as in the turning module.

In another embodiment of the idea underlying the invention, two stock feeds and a shunt that branches to a turning are connected after the printing modules. By means of this shunt, for example, a sheet printed on one side can be ejected from the stock feed path, individual stock stacks can be formed and an additional 180° deflection is provided, as well as a subsequent turning path, with which the stock materials initially printed on one side are fed to a turning module. The turning module turns the individual stock sheets, while keeping their front edge true to position. Because of the shunt connected after the printing module, individual sheets can be fed to the turning module via the turning path, during which the turned sheets can be introduced into another entrance into the feed path that bypasses the predrying module from the synchronization zone. Because of this, individual sheets can be printed on only one side or on both sides, in which this has no effect on the printing sequence within the printing unit. The shunt connected after the printing module permits a turn to be imposed on individually predetermined sheets, so that only individual sheets are printed on both sides.

The invention can be used, in particular, in a digital printing unit that can operate according to the electrography or electrophotography principle, and in whose printing module a rotational element is accommodated, on whose outer surface and electrographic, electrophotographic or, generally speaking, an imaging-carrying layer is formed.

The invention is further explained below with reference to the drawing.

The single FIGURE shows a side view of a printing unit proposed according to the invention with three different feed stations, as well as the stock feed path running in several planes, a predrying unit, three different stack introduction inputs, a double-sheet control, a predrying module, as well as several branching sites in the stock feed path.

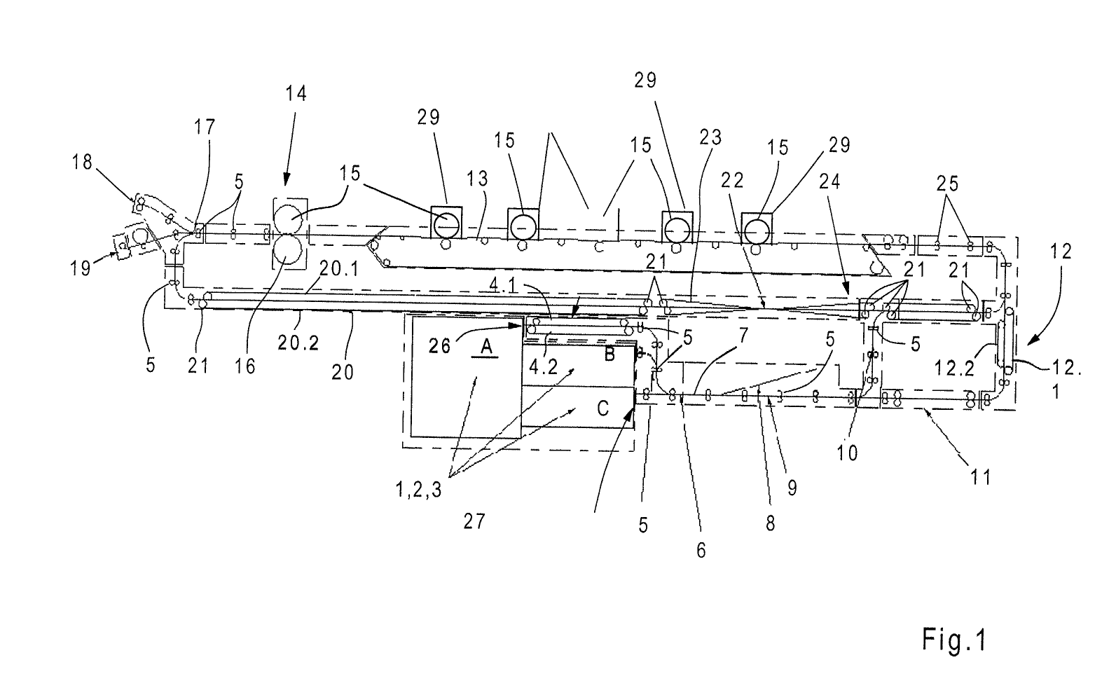

It is apparent from the depiction according to FIG. 1 that the stock being processed can be fed to the proposed printing unit at three or more different feeds.

Three feed stacks A, B and C are provided beneath a belt conveyor 20 extending essentially in the horizontal direction. The feeds can contain stock materials, like cardboard sheets, paper sheets, films or the like, and each has separation devices not further depicted here. It is ensured by the separation devices that only the uppermost sheet of the corresponding feed stack A, B or C enters the first input 26 or second input 27 or third input 28 in the stock feed path 7. The first input 26 connected to feed A contains, in the depiction according to FIG. 1, a belt conveyor 4, which consists of an upper conveyor belt 4.1 and a lower conveyor belt 4.2. By means of the first conveyor belt, the longitudinal extents of the feed stacks B and C lying beneath the conveyor belt pair 4 are bypassed. A roll pair is connected to the conveyor belt pair 4.1 and 4.2, which takes up the stock from feed A and introduces it to sheet transport path 7.

Beneath conveyor belt pair 4, the two additional feed stacks B and C are shown, to each of which a roll pair 5 is connected in the upper region. The corresponding roll pairs 5 represent the second input 27 or the third input 28 into the stock feed path 7 through the printer unit.

After adjustment of a specified separation sequence on the individual stacks A, B and C and the corresponding entry of the stock via the first input 26, the second input 27 and the third input 28 into the stock feed path 7, a double-sheet control 6 is prescribed. The double-sheet control 6 can be designed, for example, as a capacitive, inductive or transmitted light sensor. If the presence of a double-sheet is recognized by the double-sheet control 6, the double sheet is guided in the scope of double-sheet recognition through a first branch 24 into a double sheet delivery 8, from which it can then be removed. Correctly separated stock sheets are passed into the synchronization zone. A second branch 10 is connected after the synchronization zone 9. At the second branch 10 in the stock feed path 7, bypassing of a conditioning unit 11 connected after the second branch 10 can occur. If the shunt 10 is activated, the stock is not fed to conditioning unit 11, but reaches an essentially vertically extending section of the feed path, in order to be introduced into a conveyor belt pair that bypassing the conditioning unit 11. The conveyor belt pair, preferably designed as a center belt, runs around individual reversing rolls 21 and conveys the stock copies delivered at the first shunt 10 beyond the conditioning unit 11. A deflection of the stock feed path 7 that describes a 180° arc is connected to the conveyor belt pair bypassing the conditioning unit 11, before this discharges into a feed zone section 13 extending essentially in the horizontal position.

On the other hand, if the second branch site 10 is not activated, the individual stock copies that have passed the stabilization zone 9 enter the conditioning unit 11 and are acted upon and dried by it. The sheets then experience a 90° deflection, in order to enter a conveyor belt 12 extending essentially in the vertical direction. The conveyor belt 12 consists of two cooperating belts 12.1 and 12.2. The belt bypassing the conditioning unit 11 and the belt pair 12 mounted essentially in vertical arrangement combine above the predrying module 11, according to which a 90° deflection that discharges into the conveyor zone 13 is imparted to the stock copies.

In the feed zone 13, the stock sheets run through consecutively arranged printing modules 29, in which the top of the stock is provided with a printed image. After printing of the stock, the stock enters a fixation unit 14, in which the printed image is fixed on the surface of the stock.

After fixation of the print between the peripheral surfaces of the two cylinders 15 or 16 of the fixation unit 14, the sheet printed on one side enters a third branch 17 via a roll pair 5.

At the third branch site 17, three possibilities are open for further transport of the printed stock sheets into the printing module 29. On the one hand, the printed sheets can be delivered in a tablet feed 18; there is a possibility of feeding the sheets printed in printing module 29 to a stack feed 19; in addition, the printed sheets can be subjected to a roughly 180° feed path deflection, where they are introduced to a belt transport path, passing roll pairs 5. The belt transport 20 consists of two cooperating belts; an upper belt 20.1 and a lower belt 20.2, which, as already mentioned above, can be designed as elastic center belts. This offers the advantage of simple replaceability and better accessibility in the event of stock transport disorders. The center belts, introduced to a printing unit in the proposed stock transport concept, additionally offer the advantage of greater flexibility with reference to the processable stock formats and basis weights.

After passing belt transport 20, the stock sheets already printed by printing module 20 and reintroduced into belt transport 20 at the third branch site 17 are fed to a turning module 22. Turning true to the front edge of the stock sheets already printed on one side to their backside occurs in the turning module 22. The stock sheets that were printed on one side in the previous pass can therefore be turned and reintroduced to the stock sequence true to the front edge. It is therefore possible, with the solution proposed according to the invention, to print individual sheets on one side or two sides or only on one side, or all sheets on two sides without turning of the feed stack being necessary. It is also possible, by intelligent control of the third branch site 17, to impart turning, by turning module 22 only to those sheets that are to be printed on both sides with the same subject.

In similar fashion to the conveyor belt pair, which bypasses the predrying module 11, the turning module 22 and the belt conveyor 20 are provided with reversing rolls 21, around which the center belts 21 can travel.

The design of the corresponding transport elements, either as cooperating roll pairs of the same or different diameter or as center belts that grasp the center of the stock and are mounted in the center, permits easy accessibility of the prescribed deflection rolls and thus easy accessibility of the individual stock feed path sections in the event of a paper jam. Adjustments, with reference to the use of additional belt pulls that can grasp larger stock formats in the printing unit, are unnecessary, so that cost-effective manufacture of the proposed stock transport concept according to the invention can be implemented. In addition, the stock transport concept proposed according to the invention has great independence relative to the types of stock being processed, be it paper, cardboard or film and its basis weight. By using the center belt concept during stock feed through the printing unit, the smallest, down to postcard-size stock formats can also be printed in the proposed printing unit according to the invention. Costly adjustment work of the grippers, shutdown of unnecessary suction heads and gripper bridges, as was previously necessary in sheet processing printing machines, can now drop out.

The division of the stock feed path into three planes within the printing unit should be emphasized, so that very good accessibility to remove any stock running disorders that occur is attainable. The easier accessibility of all stock feed components permits easy maintenance of a printing unit provided with the stock feed concept proposed according to the invention, like a digital printer or the like.

The second branch station prescribed after the printing module permits consideration of subsequent further processing steps for the printed copies. Individual stock sheets can be taken up in a tablet feed and individually further processed, whereas in the stack feed 19, also connected to the third branch site 17, stack-like processing up to a preselectable stack height of stock copies printed on one or both sides can be laid out. The stack-wise feed possibility can be used by the downline further processing machines.

List of Reference Numbers

1 Feed A

2 Feed B

3 Feed C

4 Conveyor belt

4.1 Upper belt

4.2 Lower belt

5 Roll pair

6 Double-sheet recognition

7 Stock feed path

8 Double-sheet delivery

9 Synchronization zone

10 Second branch station

11 Conditioning unit

12 Vertical belt

12.1 Belt

12.2 Belt

13 Conveyor zone

14 Fixation zone

15 Upper cylinder

16 Lower cylinder

17 Third branch station

18 Tablet feed

19 Stack feed

20 Belt transport

20.1 Upper belt

20.2 Lower belt

21 Reversing roll

22 Turning module

23 Turning belt

24 First branch

25 Roll pair

26 First introduction stock feed path

27 Second introduction stock feed path

28 Third introduction stock feed path

29 Printing module

1. Device for transport of stock through a printing unit, in which the stock is taken up at different feed sites (1, 2, 3), to which corresponding inputs (26, 27, 28) for introduction of the stock into the stock transport path (7) are connected, and the stock passes a number of processing stations (6, 8, 11, 14, 22, 29) along its transport path (7),
characterized by the fact
that the stock feed path (7, 13) contains a number of shunts (10, 17), with which unprinted stock is fed to individual processing stations (6, 8, 11, 14, 29) or bypasses them, is fed to different delivery sites (18, 19) and/or already printed stock is reintroduced to the stock sequence via a turning (22).

2. Device for transport of stock according to claim 1,
characterized by the fact
that the stock is transported within the printing unit in superimposed planes (7, 22, 13).

3. Device for transport of stock according to claim 1,
characterized by the fact
that a common double-sheet control (6) is connected after the three or more inputs (26, 27,28) of feeds (1,2,3).

4. Device for transport of stock according to claim 3,
characterized by the fact
that at stock delivery site (8) is connected after the double-sheet control (6).

5. Device for transport of stock according to claim 1,
characterized by the fact
that a synchronization zone (9) is contained in the stock transport path to synchronize stock running.

6. Device for transport of stock according to claim 1,
characterized by the fact
that a conditioning unit (11) can be bypassed by means of a first stock path branch (10) positioned in front of it.

7. Device for transport of stock according to claim 1,
characterized by the fact
that the stock is transported by roll pairs (5, 25).

8. Device for transport of stock according to claim 1,
characterized by the fact
that the stock is transported by belt pulls (4, 12, 20).

9. Device for transport of stock according to claim 8,
characterized by the fact
that the belts of the belt pulls (4, 12, 20) are designed as elastic center belts.

10. Device for transport of stock according to claims 7 and 8,
characterized by the fact
that the stock is conveyed through the printing unit with a roll pair/belt pull combination.

11. Device for transport of stock according to claim 1,
characterized by the fact
that a third branch station (17) that generates at least two stock feeds (18, 19) and a turning (22) is connected after the printing module (29).

12. Device for transport of stock according to claim 1,
characterized by the fact
that the stock is turned in a turning module (22) with retention of its front edge position.

13. Device for transport of stock according to one or more of the preceding claims,
characterized by the fact
that stock already printed on one side is reintroduced in the feed sequence of unprinted stock after turning in turning module (22).

14. Printing machine for processing of sheet-like stock by a printing unit, in which the stock is taken up at different feed sites (1, 2, 3), to which inputs (26, 27, 28) are connected for introduction of the corresponding stock into the stock feed path (7), and the stock passes a number of processing stations (6, 8, 11, 14, 22) along its stock feed path (7),
characterized by the fact
that the stock feed path (7, 13) contains a number of branch stations (10, 17, 24), with which unprinted stock passes through individual processing stations (6, 8, 11, 14, 29) or bypasses them, is fed to different delivery sites (18, 19) and/or already printed stock is introduced to the stock feed sequence via a turning in a turning module (22).

15. Digital printing machines with a device for transport of stock through a printing unit, in which the stock is taken up at different feed sites (1, 2, 3), to which inputs (26, 27, 28) for introduction of the stock into the stock feed path (7) are connected, and the stock passes through a number of processing stations (6, 8, 11, 14, 22) along its stock feed path (7),
characterized by the fact
that the stock feed path (7, 13) contains a number of branch stations (10, 17, 24), with which unprinted stock individually passes through individual processing stations (6, 8, 11, 14, 29) or individually bypasses them, can be fed to different delivery sites (18, 19), and/or already printed stock is introduced via a turning module (22).
